(19) United States
(12) Patent Application Publication
(10) Pub. No.: US 2012/0303378 A1
(43) Pub. Date: Nov. 29, 2012

(54) SYSTEM AND METHOD FOR MONITORING AND MEASURING QUALITY PERFORMANCE OF HEALTH CARE DELIVERY AND SERVICE

(76) Inventor: Richard N. Lieberman, Baltimore, MD (US)

(21) Appl. No.: 13/479,228

(22) Filed: May 23, 2012

Related U.S. Application Data
(60) Provisional application No. 61/488,873, filed on May 23, 2011.

(51) Int. Cl. G06Q 50/22

(52) U.S. Cl. 705/2

(57) ABSTRACT

A software driven health care quality management system is disclosed. This system is user friendly, allowing easy navigation through various screens that enable the user to identify drivers of Star Rating System performance. The present invention offers easy drill-down functionality from a plan level, to a provider group, individual provider, and member level to provide actionable data that can improve the quality of care and ultimately a plan's star ratings. This system addresses each of the drivers that influence overall plan revenue, by providing an enterprise business intelligence system, designed to maximize process quality measures, promote value-based purchasing, and maximize risk-adjusted revenue for such health plans and health provider organizations.

### CROSS-REFERENCE TO RELATED APPLICATIONS

This application claims priority under 35 U.S.C. §119(e) from U.S. Provisional Patent Application Ser. No. 61/488,873, entitled “System and Method for Monitoring and Measuring Quality Performance of Health Care Delivery and Service” filed with the United States Patent and Trademark Office on May 23, 2011, the specification of which is incorporated herein by reference in its entirety.

### BACKGROUND

1. Field of the Invention

The present invention relates generally to a system and method for analyzing medical cost and utilization data. More particularly, the present invention relates to a method and apparatus for integrating medical cost and utilization data, including, typically the Federal or a inpatient, outpatient, ambulatory, clinical laboratory, intervention, and prescription drug cost data, from one or more sources for comparative analysis at the network level, provider level, or patient level within a single user environment.

2. Background of the Invention

Quality health care is the extent to which patients get the care they need in a manner that most effectively protects or restores their health. This means having timely access to care, receiving effective treatments and getting appropriate preventive care. The Affordable Care Act (P.L. 111-148), together with the Health Care and Education Reconciliation Act of 2010 (P.L. 111-152) specifies that Medicare Advantage plans will be eligible for quality bonus payments (QBPs) if they achieve certain thresholds for defined quality measures. Health plans achieving a particular star rating on a 5-star scale will receive QBP. Private Medicare health plans that are designated with either 4 or 5 stars can receive payment increases of up to 5 percent (in 2012 and 2013, 3 star plans are eligible for the QBP). Other provisions of this new legislation require private health insurance plans serving Medicare and Medicaid recipients to better manage their medical loss ratios, promote more efficient care delivery and encourage alternative financing mechanisms to fee-for-service (pay-for-volume) reimbursement.

All government-sponsored private Medicare plans (known as Medicare-Advantage plans) and many private Medicaid plans receive prospective member-level payments using a variety of different risk adjustment formulas. These formulas rely on a risk adjustment factor (RAF) specific to the persons who elect to enroll in the private health plan. A RAF is a numeric representation of a person's morbidity profile, with 1.0 denoting “average morbidity,” values greater than 1 denoting sicker than average members and values less than 1.0 denoting healthier than average members. A risk adjustment formula controls payments to health plans so that enrollees who are sicker than average garner higher payments for the plan and plans enrolling healthier than average enrollees receive less payments than the average plan.

Health plans receiving risk-adjusted payments have an incentive to optimize their risk adjustment factors (RAFs). At the same time, the health plan sponsor, typically the Federal or a State government, needs to ensure that risk-adjusted health plan's RAFs are accurate representations of the morbidity of the enrolled members. The plan sponsor can audit the RAFs by abstracting morbidity information from medical records and comparing the documented illness burden to the RAF calculated from administrative data. The RAF formula changes depending on the state in which the plan is conducting business. Some RAF algorithms are available for public use and others are proprietary.

Relative Resource Use (RRU) measures indicate how intensively plans use physician visits, hospital stays, and other resources to care for members. When evaluated alongside quality measures, RRU measures make it possible to consider quality and spending simultaneously. Examples of RRU measures include the number of visits to primary physicians, use and cost of diagnostic radiology services, hospital inpatient admissions and lengths of stay, and rates of surgical or other therapeutic interventions.

A common limitation of evaluating RRU measures is the lack of effective adjustment for the underlying health status of the patients being compared. If a health plan wants to compare the efficiency of two physician groups (e.g., two Individual Practice Associations—IPAs) based on the number of inpatient hospital days of care, often the underlying morbidity of the members prevents effective comparison of the desired metric. This is because sicker people tend to use more inpatient hospital days, irrespective of the practice patterns of the IPAs under study. This is where effective risk adjustment integrated into the analysis is necessary to control for variations in underlying morbidity. Integrating risk adjustment algorithms into analyses of RRU measures is key to creating actionable results that health plans and physicians can use to promote more efficient delivery of health care services.

Some RRU measures are metrics for both resources and quality. For example, the rate of avoidable hospital admissions or the rate of preventable hospital readmissions in a group of Medicare or Medicaid recipients who have elected to enroll in a health plan are both quality and RRU measures.

The level of resources that plans expend to care for members and the quality achieved are, in general, weakly related. In some instances, quality and resource use appear to be inversely related (i.e., higher quality is associated with lower resource use). Therefore, quality and resource use should be considered together when comparing health plans.

When linked with quality data and risk adjustment, RRU measures help members, plans, employers, benefit managers, and other interested groups make informed choices about health care services. Members get a more detailed look at the value of services they pay for, while plans can see how effectively they use resources, compared to other plans, when delivering health care.

### SUMMARY

It is, therefore, an object of the present invention to provide a health care quality measurement system that avoids the disadvantages of the prior art. One object of the present invention is to provide a computer implemented healthcare quality management system that comprises at least one health information data module configured to process health information data and present processed health information data to a user at plan, practice, individual practice association, physician group, individual physician and enrollee levels.

It is another object of the present invention to provide a system that uses health information data from the Health Effectiveness Data and Information Set (HEDIS), PQ4 program data, Consumer Assessment of Health Care Providers and Systems (CAHPS) data, Health Outcome Survey (HOS) data, health management company generated data, and health care provider generated data on its modules in order to generate processed health information for the users of the system.

It is a further object of the invention to provide the processed health information data to a user, such as an Individual Practice Associations (IPA) executive, a quality improvement staff member, a medical practice manager, a health insurance network manager, a health insurance network staff member, a health care case manager, a disease manager, a risk adjustment team member, a healthcare service provider, and a plan enrollee, among other individuals.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows an example of a login page for a system according to an embodiment of the present invention.

FIG. 2 shows an example of a home page for a system according to an embodiment of the present invention.

FIG. 3 shows an example of a dashboard summary page for a system according to an embodiment of the present invention.

FIG. 4 shows an example of a report card page for a system according to an embodiment of the present invention.

FIG. 5 shows an example of a Quality Management report page for a system according to an embodiment of the present invention.

FIG. 6 shows an example of an IPA report page for a system according to an embodiment of the present invention.

FIG. 7 shows a first example of a provider report page for a system according to an embodiment of the present invention.

FIG. 8 shows another example of a provider report page for a system according to an embodiment of the present invention.

FIG. 9 shows an example of a member report page for a system according to an embodiment of the present invention.

FIG. 10 shows an example of a member alert page for a system according to an embodiment of the present invention.

FIG. 11 shows an example of a member information page for a system according to an embodiment of the present invention.

FIG. 12 shows an example of a member quality compliance page for a system according to an embodiment of the present invention.

FIG. 13 shows an example of a member provider summary page for a system according to an embodiment of the present invention.

FIG. 14 shows an example of a member utilization profile page for a system according to an embodiment of the present invention.

FIG. 15 shows an example of a member problem list page for a system according to an embodiment of the present invention.

FIG. 16 shows an example of a member pharmacy summary page for a system according to an embodiment of the present invention.

FIG. 17 shows an example of a member intervention page for a system according to an embodiment of the present invention.

FIG. 18 shows an example of a plan summary report page for a system according to an embodiment of the present invention.

FIG. 19 shows an example of a provider list page for a system according to an embodiment of the present invention.

FIG. 20 shows an example of a member list page for a system according to an embodiment of the present invention.

FIG. 21 shows an example of a plan score page for a system according to an embodiment of the present invention.

FIG. 22 shows an example of an IPA risk score report page for a system according to an embodiment of the present invention.

FIG. 23 shows an example of a specific IPA risk score report page for a system according to an embodiment of the present invention.

FIG. 24 shows an example of a provider IPA risk score report page for a system according to an embodiment of the present invention.

FIG. 25 shows an example of a non-compliance report page for a system according to an embodiment of the present invention.

### DESCRIPTION OF PREFERRED EMBODIMENTS

The invention summarized above may be better understood by referring to the following description, which should be read in conjunction with the accompanying drawings and claims. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In the below description of the invention, EssentialStars is the name of the interactive system and method for monitoring and measuring quality performance of health care delivery and service. An object of the invention is to provide a health care quality measurement system having a software module to measure health care quality. Another object of the present invention is to provide a health care quality measurement system that uses HEDIS measures. Another object of the invention is to provide a health care quality measurement system having a module to evaluate interventions.

Another object of the present invention is to provide a system that enables integrated calculation and display of quality metrics, efficiency metrics, and risk score metrics for a health care plan. A related object of the present invention is to provide a system that enables quality metrics calculated and displayed for a variety of different temporal dimensions. Another object of the invention is to provide a health care quality measurement system having a software module to measure administrative and management efficiency. Another object of the invention is to provide a health care quality measurement system having a software module for risk management. Another object of the invention is to provide a health care quality measurement system using a common data warehouse.

In accordance with the above and other objects, a software driven health care quality management system is disclosed. This system is user friendly, allowing easy navigation through various screens that enable the user to identify drivers of Star Rating System performance. The present invention offers easy drill-down functionality from a plan level, to a provider group, individual provider, and member level to provide actionable data for improving the quality of care and ultimately a plan's star ratings. This system addresses each of the drivers that influence overall plan revenue, by providing an enterprise business intelligence system, designed to maximize process quality measures, promote value-based purchasing, and maximize risk-adjusted revenue for such health plans and health provider organizations. In one embodiment, the source code is in the SAS syntax and the data and calculations are made on a SAS server, but various conventional database programs, source code and server configurations may be used to enable this database/data feed and algorithm-driven system.

EssentialStars is comprised of three independent modules and unique functionality that pulls together information from each of the modules using a common data warehouse, providing an integrated platform for the user. The system provides multi-level access for a user in a single computing environment and through a single, integrated user interface. Specifically, the user may use such single, integrated platform to access, analyze, and report on information that is particularly applicable to a user at plan, practice, individual practice association, physician group, individual physician and enrollee levels. The “common data warehouse” is a database that serves as the repository for all raw data collected by the system and used by each of the modules. The system also provides comprehensive reporting and a one-stop shop for distribution of consistent and reliable information to plan and IPA executives, quality improvement staff, medical management, network management, case and disease management, risk adjustment teams, providers and others.

Once a user reaches a level of information needed for reporting, the user can generate a PDF file or produce an Excel file for further analysis and manipulation. All the information is reportable. In some embodiments, other reporting formats are used. For example, a user interface may provide reports on a screen or through a mobile application.

According to a preferred embodiment, the present invention enables a web-based application available to a client/plan, as well as engaged healthcare providers, for ongoing monitoring and reporting of each of the measures associated with the system modules. The system also provides analysis of the impact of each of any interventions implemented by the plan to optimize quality, efficiency and risk management. An “intervention” is any type of action recommended to an individual physician, a practice, an individual practice association, a plan or plan manager. The intervention is also any action taken in order to change a projected outcome based on current practices in association with a healthcare plan.

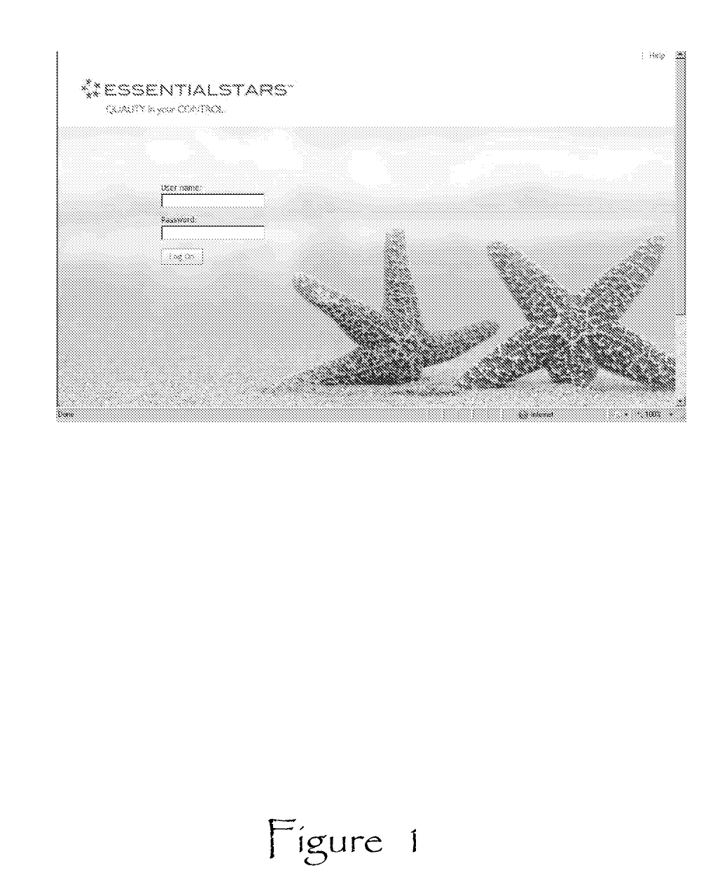

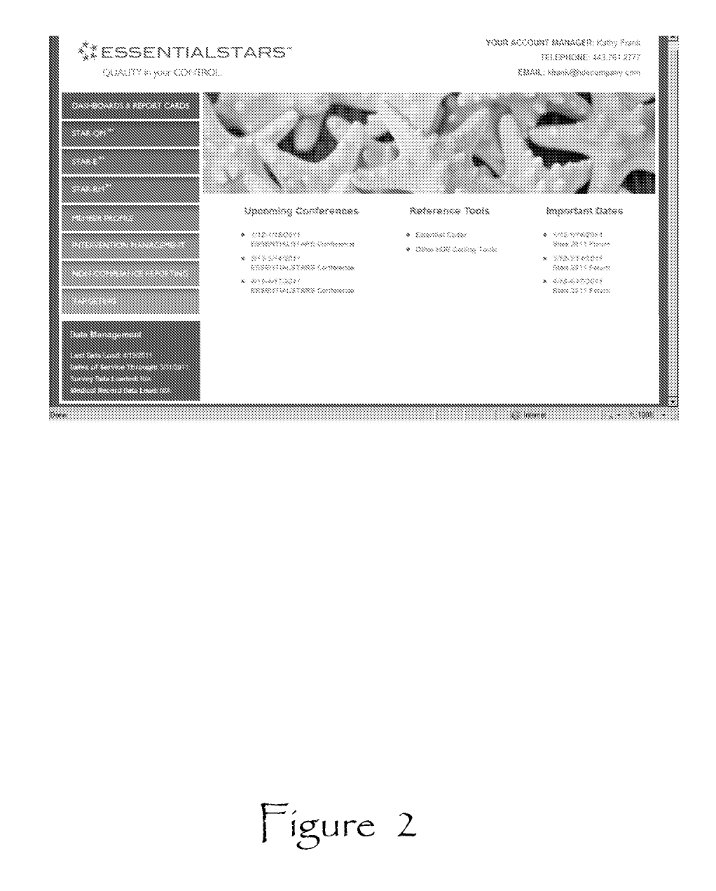

For access to the system, FIG. 1 shows an example of a Login Screen. A user simply enters a UserID and Password in the appropriate boxes and clicks the Log On box, which leads to the Home Page shown in FIG. 2. The Home Page is where the user accesses the modules and system features of the present invention. The Home Page also provides the latest information about the data that has been loaded into the system, important contact information, key dates to remember, and links to coding tools. The Home Page may show the date that the last data load was completed. Typically, organizations will provide a data refresh monthly, but this could be more or less frequent depending on the organization. A new dataset is loaded into the system as soon as it is received. The “Last Data Load” field is updated and the latest date of service included in that dataset is displayed as “Dates of Service Through”.

Not all plans conduct their own surveys, but for those that do and wish to have this information loaded into the system, the Home Page will indicate when that survey data was last loaded. Similarly, if a plan chooses to load their medical record data into the system to supplement HEDIS administrative data, the date it is loaded is displayed next to “Medical Record Data Loaded”.

The system uses a comprehensive data feed from the client (e.g., a healthcare plan) including the following data types:
Health plan member demographics and enrollment
Provider information [demographics, address, and specialty]
Insurance claims data from medical services and prescription drugs
lab result values
Data supplied by CMS (Centers for Medicare and Medicaid Services)
   MMR (Monthly Member Report—transaction report of what the plan is being paid for their plan based on its demographics and other measures)
   MOR (Model Output Report—shows which diagnoses of the 70 available which contributed to the risk score calculatable from the MOR using an algorithm provided by CMS, it is contemplated that the system is updated as more diagnoses and information becomes available from CMS)
   Survey results, particularly data from the Consumer Assessment of Healthcare Providers and Systems (CAHPs, these surveys are available to the public through the United States Department of Health and Human Services) and the Medicare Health Outcomes Survey (HOS, these surveys can be obtained from the National Committee for Quality Assurance—NCQA)
medical record reviews
Program interventions (steps taken to encourage members to take certain steps for furthering their healthcare)

The system allows plans to load information from disparate databases and supplement health plan transaction data (e.g., claims and encounter records). This provides additional information about the nexus between health care services delivered and interventions associated with members and allows more comprehensive analysis of the effectiveness of these interventions to improve quality measures.

From the Home Page, users can access coding tools and other reference materials simply by clicking on the links provided. ESSENTIAL CODER: MEDICARE ADVANTAGE HCC MANAGER FOR ICD-9-CM is an enhanced E-book designed specifically for Medicare Advantage plans to assist in optimal coding of HCCs (Hierarchical Condition Codes). Other information may also be available to users such as the document issued by CMS describing the technical specifications for the Star Rating System. Additional reference materials may be made available.

The Dates to Remember section of the Home Page simply notes upcoming dates that are newsworthy to the user such as those related to HEDIS data collection, CAHPS or HOS surveys, or CMS sweep dates for submitting RAPS data files. Old dates will drop off and new event dates will appear as they become relevant. A link to a complete calendar of events may also be made available. The Account Manager assigned to a user organization and their contact information may be displayed on the Home Page.

A menu of options enables a user to select which module or function within the system to use. This is a starting point. There are different navigation paths within the system provided to address specific business needs and the desired information that the user is interested in reviewing. In one exemplary embodiment of the present invention, the system comprises three modules: a quality metrics module (STAR-QM), an efficiency metrics module (STAR-E), and a risk management module (STAR-RM). A first screen provides an initial plan view for the measures associated with each of these modules. Subsequent screens allow a user to drill down on each of these measures to the provider group, individual provider, or member level.

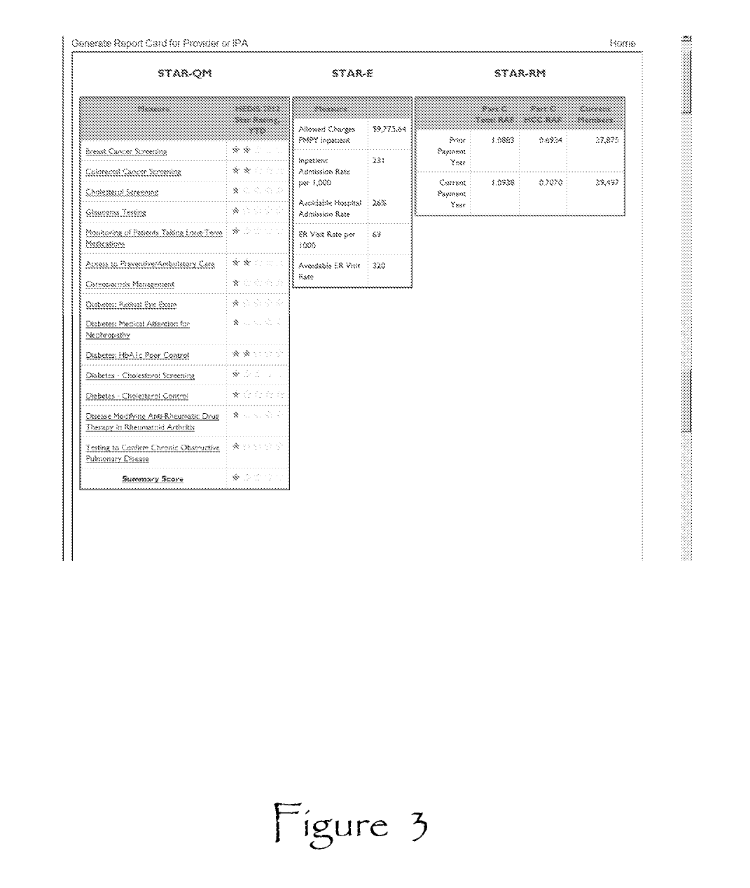

The system permits the integrated calculation and display of quality metrics, efficiency metrics, and risk score metrics. An executive dashboard brings together key data elements from all three modules (i.e. the quality module, the efficiency module, and the risk score module) and allows drill down by a specific provider group or provider with peer comparisons. In a preferred embodiment, the Home Page provides access to Executive Dashboards and Report Cards. FIG. 3 shows summary information across STAR-QM, STAR-E, and STAR-RM at the plan level. STAR-QM focuses on the quality management functions of the system. In particular, STAR-QM or the quality metrics module provides information concerning specific measures of quality based on treatment of certain conditions. STAR-E or the efficiency metrics module focuses on the management and administrative efficiency functions of the system, including revenue management, avoidable and non-avoidable inpatient admission rates, and preventable emergency department encounters. STAR-RM or risk module focuses on the risk management functions of the system, including management of a plan's RAFs. A user can focus on a particular provider group or individual provider. In some embodiments, a user can search for a provider group by name or an individual provider by name or provider ID.

In a preferred embodiment, the Home Page also provides access to comprehensive detailed information about a given member across all the modules, through the Member Profile Link. Member information is described in more detail below. If desired, a user can search for a particular member by name or member ID.

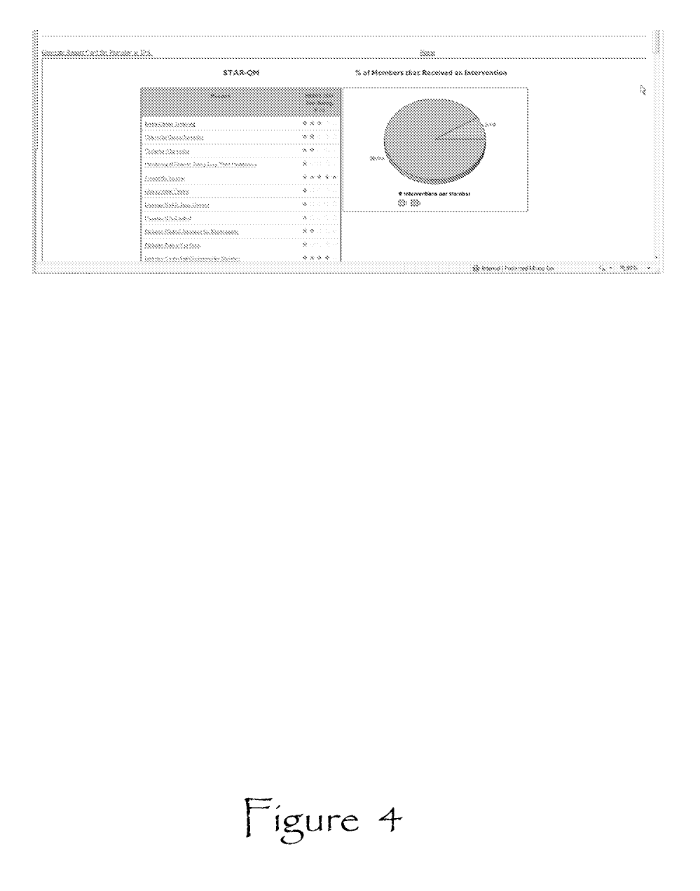

The Intervention Management link on the Home Page directs a user to a screen that will display how the organization is doing with regard to interventions and other actions taken in response to the metrics calculations. There are graphical displays of trended quality measures for a specific intervention or groups of interventions, such as shown in FIG. 4. An “intervention” is a process undertaken by a plan or user to modify or improve a particular metric.

The Targeting link on the Home Page directs a user to the screen that allows them to identify the members or providers identified for chart retrieval, program interventions, or activities such as prospective assessments. Preferably, the system identifies members for whom medical record reviews have been conducted for either HEDIS or risk adjustment so scanned images can be referenced for subsequent data collection. The Non-Compliance Reporting link on the Home Page, described in further detail below, identifies members requiring additional follow-up to assure compliance with any outstanding HEDIS measure.

Calculations are generated periodically (based on updates to the data feed) for each of the various quality, efficiency and risk adjusted measures (measures defined by NCQA, CMS, AHRQ and private entities) which are desirable to monitor and track in order to maximize plan reimbursement and improve plan performance. When the data feed changes or is modified (truncated data, or different data), the quality scores, efficiency scores and risk scores are recalculated for the selected time period. This permits the user to analyze the calculation results that would have been obtained had the data feed in fact included those modifications. This, in turn, enables the user to determine which variables in the data feed should be the focus of future efforts to increase, or decrease as the case may be, the calculated measures. Those calculated measures are, in turn, tied to plan financial bonus calculations, so that the plan or user of the system can determine the anticipated financial impact of such changes to the data feed and the resulting measure calculations.

The Quality Metrics Module

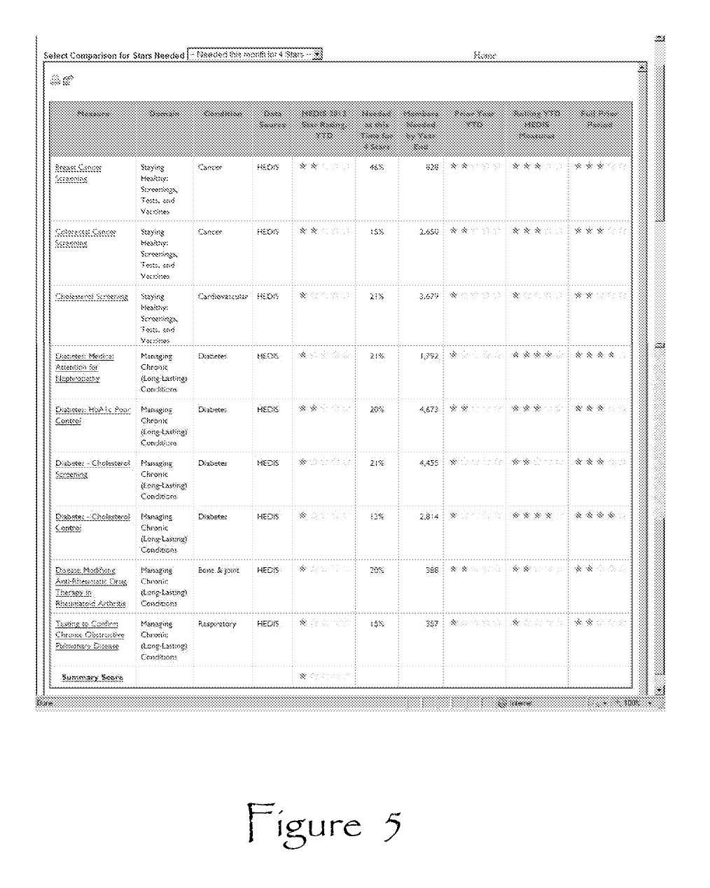

Referring to FIG. 5, the plan level screen of STAR-QM module lists the measures for which the system has calculated star ratings. At a minimum, the HEDIS measures based on administrative data is generated. HEDIS is the Healthcare Effectiveness Data and Information Set—an information tool developed and maintained by the NCQA (National Committee for Quality Assurance) used by more than 90 percent of America's health plans to measure performance on important dimensions of care and service. Altogether, HEDIS consists of several measures across multiple domains of care. Because so many plans collect HEDIS data, and because the measures are so specifically defined, HEDIS makes it possible to compare the performance of health plans on an “apples-to-apples” basis. Health plans also use HEDIS results themselves to see where they need to focus their improvement efforts. In the system of the present invention, the measures may include, but not be limited to, the following:
Breast Cancer Screening
Colorectal Cancer Screening
Cardiovascular Care—Cholesterol Screening
Diabetes Care—Cholesterol Screening
Glaucoma Testing
Appropriate Monitoring for Patients Taking Long Term Medications
Access to Primary Care Visits
Osteoporosis Management in Women who had a Fracture
Diabetes Care—Eye Exam
Diabetes Care—Kidney Disease Monitoring
Diabetes Care—Blood Sugar Controlled
Diabetes Care—Cholesterol Controlled
Rheumatoid Arthritis Management
Testing to Confirm Chronic Obstructive Pulmonary Disease

For each of these measures, the HEDIS domain and condition are cited and HEDIS is listed as the data source. This information is displayed in columns as noted in FIG. 5. The user can hover their mouse over any of the HEDIS measure names to obtain a brief description of that particular measure for the user.

If plans provide medical record data to supplement the administrative data on which these measures are based, such data is included in the HEDIS measure calculations. Additionally, if an organization conducts its own surveys with a sample large enough to allow reporting by provider group or individual provider; that information can be added to the database and identify comparable measures that could be mapped to the CMS Star Rating System. Plans that have P4Q programs that use measures different from HEDIS can be reported as well.

The system uses a probabilistic classification algorithm for health plans to project the likelihood of achieving compliance with quality star rating thresholds within measurement and data submission timeframes established by NCQA and/or CMS. The classification algorithm also identifies medical records needed for HEDIS data collection and retrospective chart review, utilizing targeting to group providers geographically and identifies medical records most worthwhile to acquire.

In use, an organization can select an overall goal of 3, 4, or 5 stars, based on the Star Rating System performance. In a preferred embodiment, a drop-down menu is presented at the top of the STAR-QM Plan Level Screen, as shown in FIG. 5. Simply by clicking on the arrow, the user can select the 3, 4 or 5 star comparisons. Information is populated in the various columns. All star calculations are based on the most recent CMS benchmarks available.

Based on the plan goal selected, the screen reflects a “current year-to-date” or “truncated” HEDIS measure that was calculated based on NCQA specifications, although the enrollment requirement was relaxed so that members enrolled as of the beginning of the data collection period may be included. This measure is produced to give the organization a feel for where they currently are with each HEDIS measure. It reflects data that has been loaded into the system. As described above, the dates of service for this data load are reflected on the Home Page under the “Dates of Service Through” field.

The system allows user to examine quality metrics in different temporal dimensions, including but not limited to: 1) looking at the year's prior data and calculation results; 2) reviewing year-to-date calculation results from a right-censored dataset; 3) next to last year's measure, and 4) allows users to look at different time slices (quarterly or monthly to-date and historical quarterly or monthly) for comparison purposes.

To understand the current year-to-date HEDIS measure better, the system offers a reference point, such as the score needed at this time for 4 stars. Had the user selected the goal of 5 stars, it would read, “Needed at this time for 5 Stars” and similarly for a goal of 3 stars. This rate is based on the assumption that a HEDIS measure progresses equally over the months, so if the current HEDIS measure reflects dates of service through a particular date, the rate needed at this time indicates where the plan should be today in order to achieve their goal by the end of the year. For example, in FIG. 5, looking at breast cancer screening, the plan would need to be at least at 46% compliance to be on track for achieving 4 stars for this measure at the end of the calendar year. The user can hover their mouse over the stars in HEDIS Star Rating YTD column to see the actual rate for breast cancer screening and compare it to the projected goal.

The system displays how many health plan members are needed to be brought into compliance in order to achieve a 3, 4, or 5 star status. In the column labeled “Members Needed by Year End”, the user is provided additional information to identify how much work is ahead of them. The “Members Needed by Year End” field displays for the user how many members eligible for each of the measures remain to be compliant for the plan to meet their goal by the end of the calendar year. In the example above, 828 women remain in need of breast cancer screenings conducted before the end of the year. Preferably, the system provides users with three different comparison measures: a “Rolling YTD HEDIS Measure”, a “Prior Year YTD” measure, and a “Full Prior Period” measure.

The Rolling Year-To-Date HEDIS Measure is designed to give the user a feel for how the measure is progressing over time. It is based on a full data collection period but the begin and end dates of the measure adjust to reflect the current point in time. Each time the measure is recalculated with a new data load, the end date is reflect the last date of service in the dataset and the start date of the measure is adjusted accordingly. As with the other star calculations, the user can hover the mouse over the star to view the number of eligible members for the measure as well as the number who are compliant and the associated rate.

The Prior Year Year-to-Date HEDIS Measure is similar, but reflects the same period one year earlier. This allows the plan a look back period to see if they are doing any better this year than they did in the prior year at this point in time. Again, the user can hover their mouse over the star to view the number eligible, compliant, and the rate for that particular measure. Finally, the Full Prior Period is the equivalent of the plan's prior year HEDIS measure. As with all star illustrations on this screen, hovering the mouse over the star displays the number of eligible members for that particular measure, as well as the number of compliant members and the rate.

In the example shown in FIG. 5, all of the Current Year-to-Date measures are either at one or two stars, based on the CMS year-end benchmarks. Using breast cancer screening as an example the HEDIS 2012 Star Rating YTD measure is at 57% (viewed by hovering the mouse over the star rating). Assuming breast cancer screenings are equally distributed through the 24-month data collection period, a plan would need to be at a 46% compliance rate at the time this report was generated. This is displayed in the column titled “Needed at this Time for 4 Stars”. Therefore, the health plan is well on their way to meeting their 4 star goal for this measure. Furthermore, at this time last year, they were only at 35% and their Full Prior Period measure was only 46% (also viewed by hovering the mouse over the star rating).

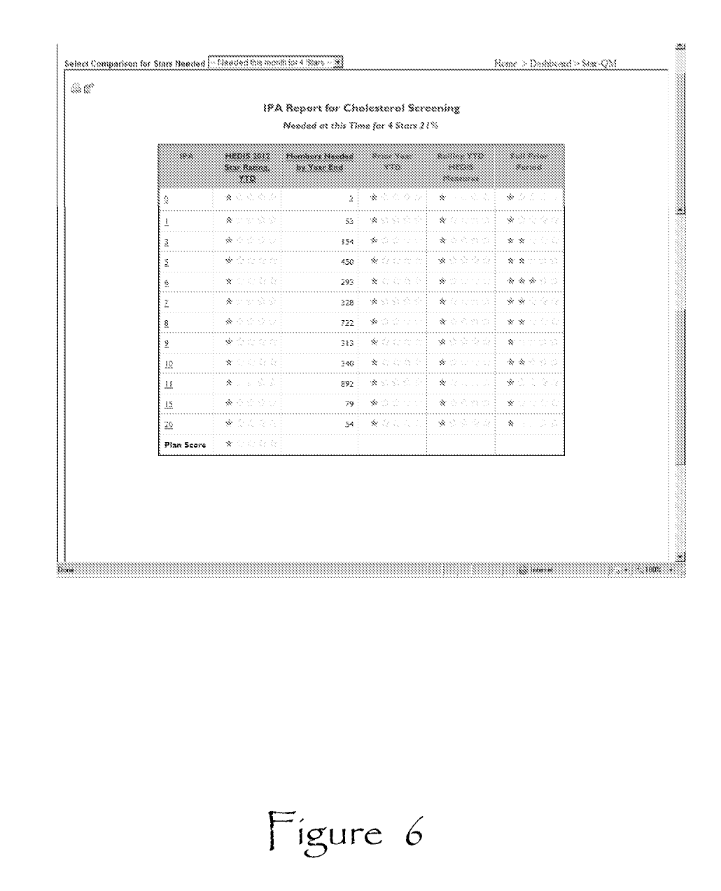

FIG. 6 shows all the IPAs for a particular HEDIS measure. In the example of FIG. 6, the HEDIS measure is for Cholesterol Screening. Similar to the screen shown in FIG. 5, the user can select whether the goal for the plan is to be at 3, 4, or 5 stars by the end of the year. The various HEDIS measures are populated for each provider group/IPA, and the number of members needed by year-end for each IPA can be displayed.

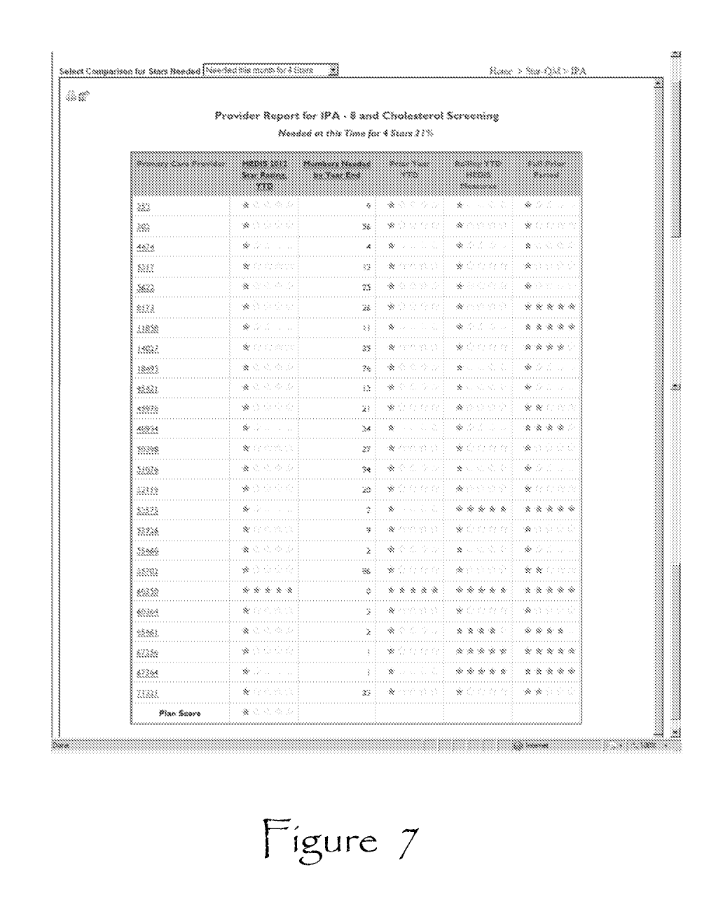

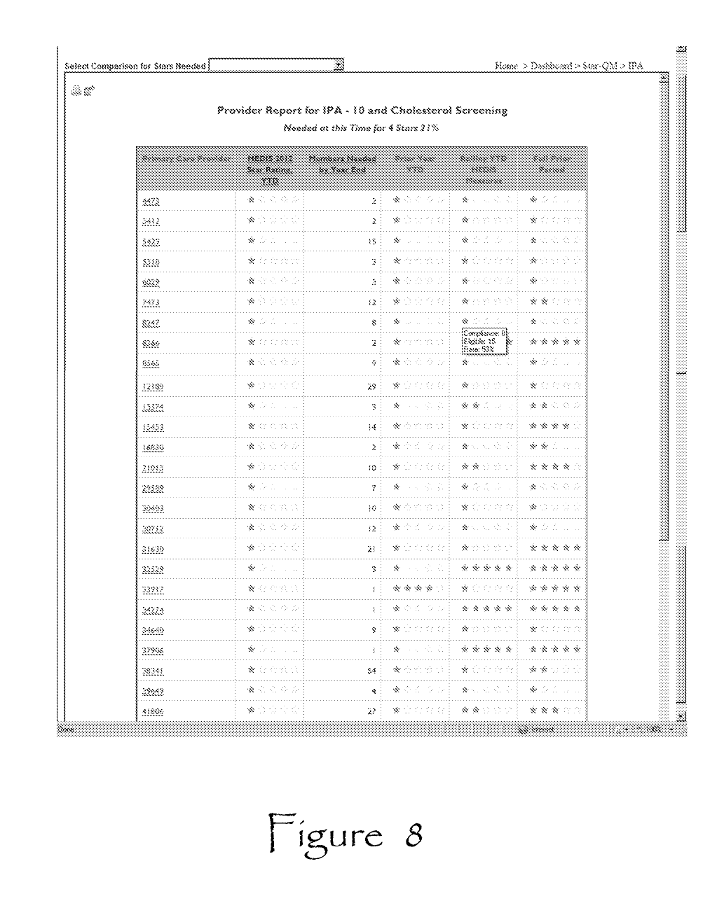

To examine the performance for a specific measure and IPA, simply click on the IPA for which more information is desired. FIG. 7 shows the Provider Report for IPA-8 and Cholesterol Screening. FIG. 8 shows the Provider Report for IPA-10 and Cholesterol Screening. The Individual Provider screen for each quality measure will follow the same format as that for the previous screen. Preferably, the Current HEDIS measure year-to-date is displayed, as is the number of members needed to be compliant by the end of the year to achieve the 3, 4, or 5 star goal selected by the user. The Rolling HEDIS Measure, the PriorYear-to-Date Measure, and the Full Prior Period HEDIS Measures, as described above, may also be displayed.

In the example shown in FIG. 7, provider 5622 for cholesterol screening is only at a one star rating so far this year and there are 45 eligible members, 14 of whom have completed their cholesterol screening for the current data collection period. Provider 60350 is shown as already achieving 5 stars, but if you hover over the star rating, you can see that this provider only has three eligible members assigned to him/her but all have completed their screening for the data collection period. In order to know how to proceed next, the provider needs a list of members that are out of compliance so that the healthcare provider can contact those members or at least be aware of the members who need cholesterol screening. When the patients come in to see the physician, the healthcare provider can remind the patient of the need for the required screenings. The next two screens provide actionable data to the provider or his/her case manager.

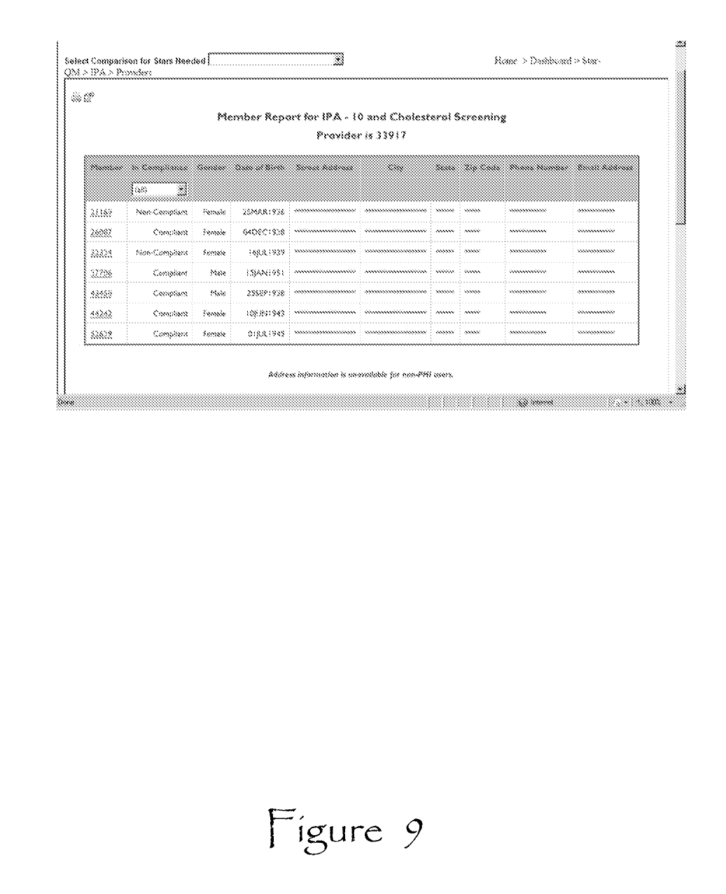

By clicking on an individual provider, the user will be displayed a list of members who are assigned to that particular primary care provider. FIG. 9 shows a Member Report for IPA-10 and Cholesterol Screening for Provider 33917. Each member who is eligible for the quality measure being reviewed is listed on the screen. For each member, it is noted whether they are compliant or not compliant with the particular quality measure. Additional information about the member is available by clicking on the member number and the user is taken to the comprehensive member profile.

The user; whether plan or provider, could use the information in FIG. 9 to identify those members who need to have their cholesterol screening completed by the end of the year. Necessary demographic information is displayed to appropriately identify the members. The screen can be saved as a PDF file that can then be downloaded or as an Excel spreadsheet. It is contemplated that, in some embodiments, reports can be generated and saved for this information. Similar information is available through the Non-Compliant Reporting function to be discussed later. In a preferred embodiment, the system displays spatially, charts to chase for plan interventions. It also has a drill down capability to view results on a state, county, or zip code level. Preferably, the system creates targeting lists for provider offices.

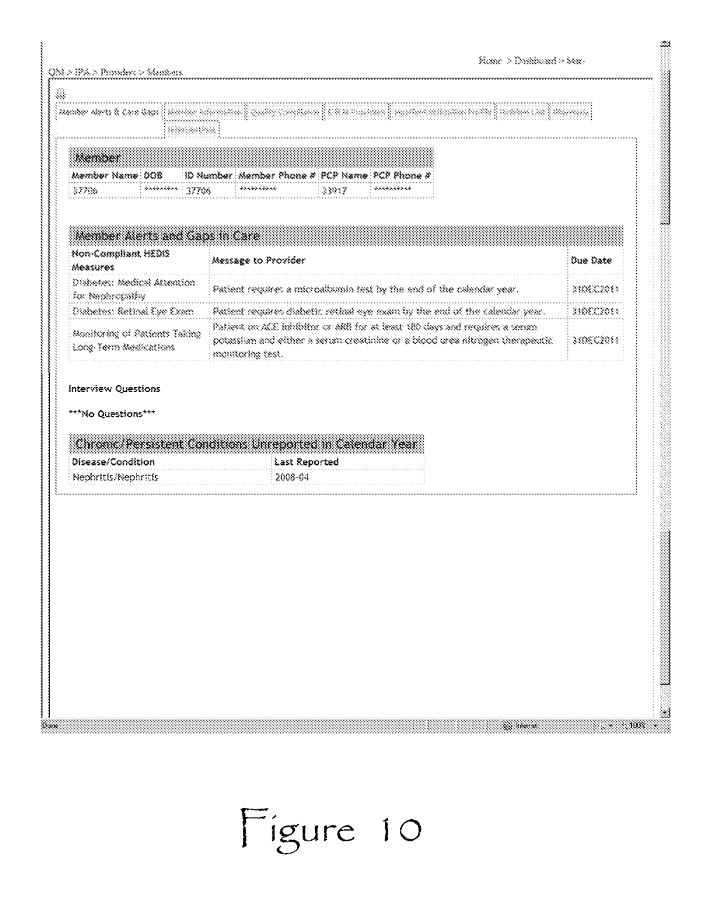

FIGS. 10-17 show examples of a comprehensive member profile. The primary audience for the Member Profile is typically a provider or care manager, disease management staff or health coaches. These are the groups that would be most interested in this level of detail and could act on the information provided either by ordering tests or by communicating with the member directly. The Member Profile is meant to be a tool for clinicians, care managers, disease managers, and health coaches. It provides a comprehensive view of the member and includes encounters across providers.

The Member Profile is comprised of several tabs, each one providing detailed information on the member. Information related to each of the tabs is displayed by clicking on the particular tab. In some embodiments, a user can view the entire member profile by clicking on a Show All link. A print out of the entire Member Profile can be obtained simply by clicking on the printer icon.

The system provides a one-page summary that alerts and prompts a provider to address gaps in care and can be included in the member's medical record. The initial screen will display the member demographic information and the Alerts and Care Gaps tab, as shown in FIG. 10. The Alerts and Care Gaps tab displays a list of all screenings that need to be ordered, non-compliant labs related to HEDIS measures, chronic and persistent HCC conditions that were reported in prior years but not in the current year; medication refill adherence outliers, or any measure the organization wants to monitor and alert the provider or case manager to address with the member. The Alerts and Care Gaps is intended to be a one stop shop for the user to see any issues that need to be addressed with the member and are noted under the various individual tabs.

In addition, the Alerts and Care Gaps tab prompts providers to ask their patients certain questions, such as about getting a flu shot, the pneumonia vaccine, their level of physical activity and when age and sex appropriate, whether their patient has difficulty with urinary incontinence or if they have fallen or have a problem with their balance. These questions tie back directly to HOS survey questions.

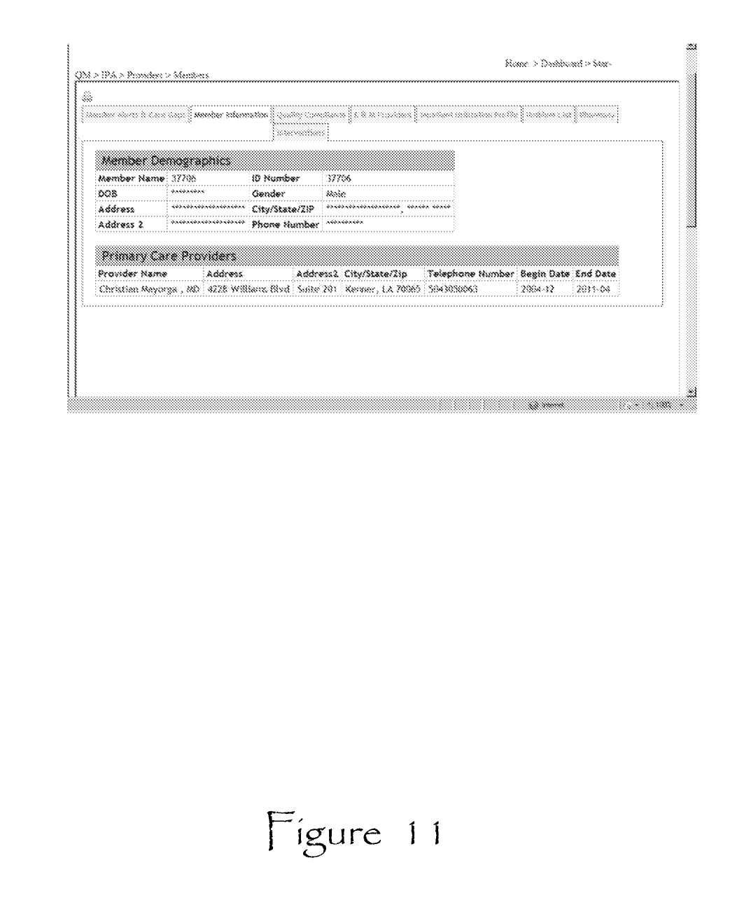

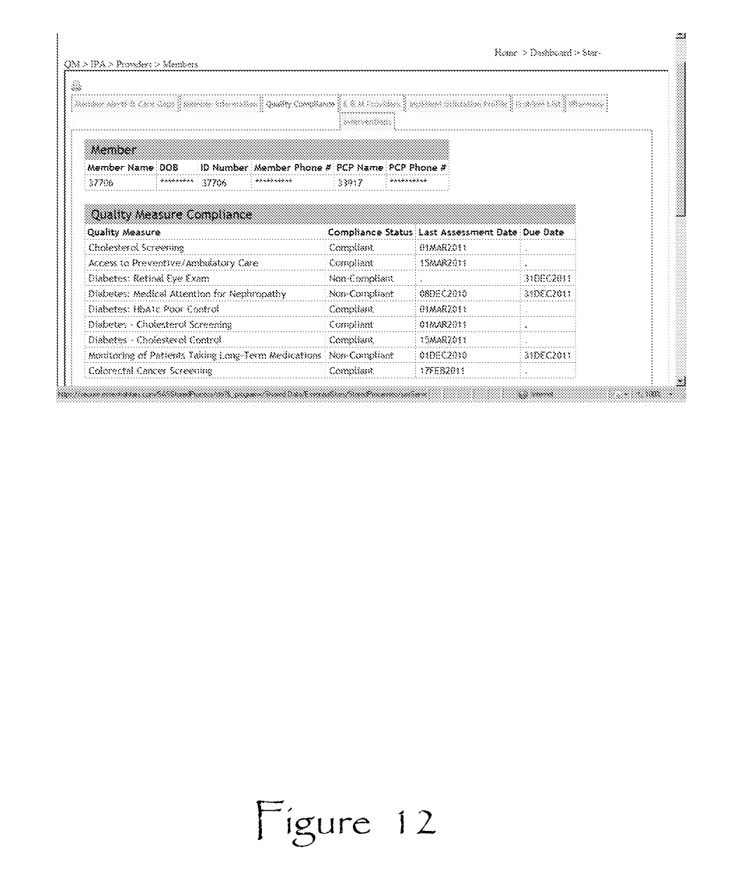

The Alerts and Gaps in Care report provides the practitioner with all the information on missing HEDIS data, non-reported HCC conditions, medication adherence issues, and avoidable hospitalizations. Information that is more detailed is available within the individual tabs to view visit history, access to specialty care, all patient conditions, and medication history In addition, the provider will be prompted to ask age and sex specific questions that tie back to survey questions that members are asked for the CAPIPS and HOS surveys. The Member Information tab shown in FIG. 11 displays demographic information for the member and primary care provider. FIG. 12 shows the Quality Compliance tab. The Quality Compliance tab summarizes all the star related HEDIS measures for which the member is eligible. For each measure, the member's compliance with the measure is displayed as is the last date in which the screening or procedure was conducted.

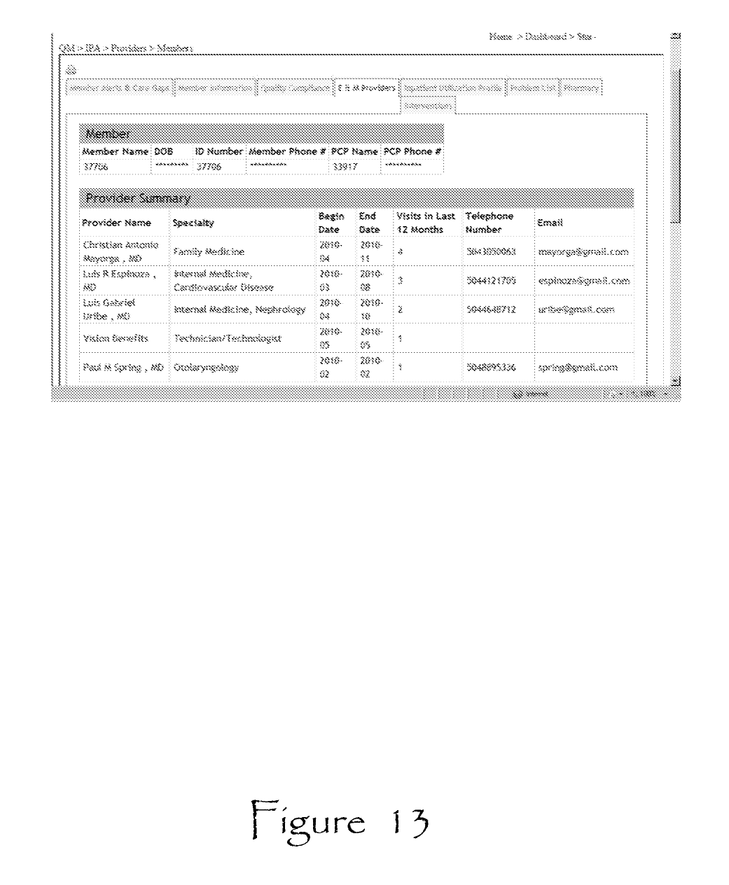

FIG. 13 shows the Providers Summary tab. The Providers Summary tab displays all the providers the patient has seen throughout the data collection period. Each unique provider is displayed with the first and last date of the visits with that provider. Also displayed is a count of the number of visits the member had with that particular provider in the last 12 months, and the provider's phone number and email address if available in the client's database.

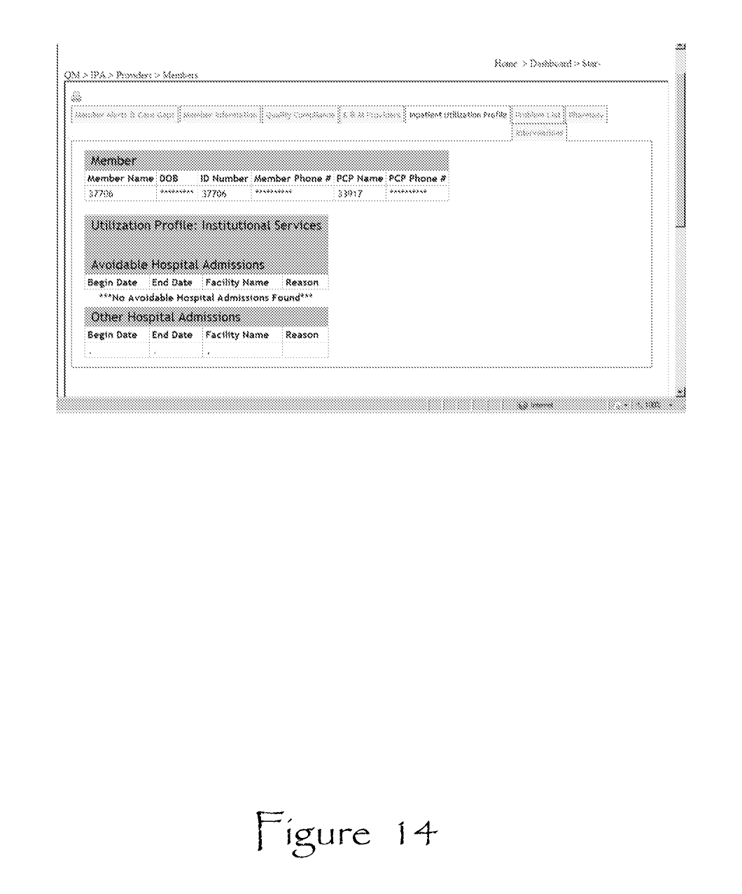

The Utilization Profile tab, shown in FIG. 14, displays all the member's hospitalizations during the data collection period. Hospitalizations are categorized as either “avoidable” or “unavoidable”. Avoidable hospitalizations can also be referred to in the literature as “ambulatory care sensitive admissions”. Ambulatory care sensitive admissions are defined as “those for which good outpatient care can potentially prevent the need for hospitalization or for which early intervention can prevent complications or more severe disease”. Admitting diagnoses that would fall under the category of “avoidable” hospitalizations, as displayed in the Utilization Profile tab include: adult asthma, dehydration, diabetes, congestive heart failure, CORD, hypertension and bacterial pneumonia.

In some embodiments, the member's medication history is viewed by clicking on a Medications History tab. Preferably, medications are grouped by drug class. The date the first prescription was filled and the date of the last prescription filled may be reported for the data collection period.

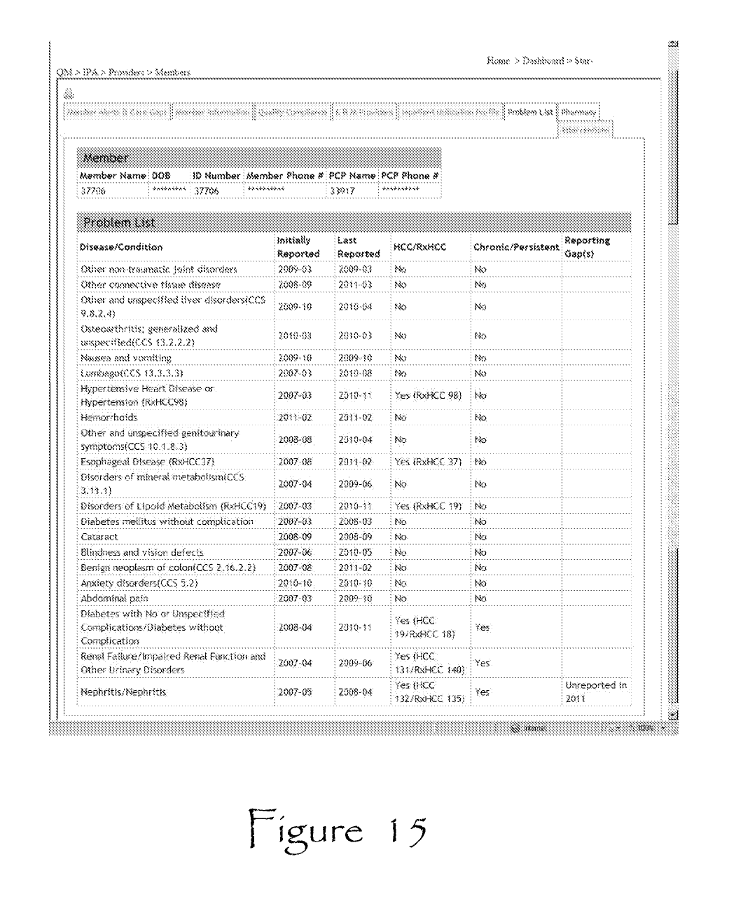

The Member Problem list, as shown in FIG. 15, is accessed by clicking on the Problem List tab. This view lists all of the conditions reported for the patient during the data collection period and indicates the first time and last time it was reported. If the condition relates to a medical HCC or an Rx HCC, a “yes” or “no” is indicated in the HCC/RxHCC column. If the condition does relate to either a medical or pharmacy HCC, the code for the HCC is indicated in parentheses. The last column indicates whether the medical HCC was chronic and persistent, if yes and it was not reported in the current year, the condition is noted as unreported for the current payment year.

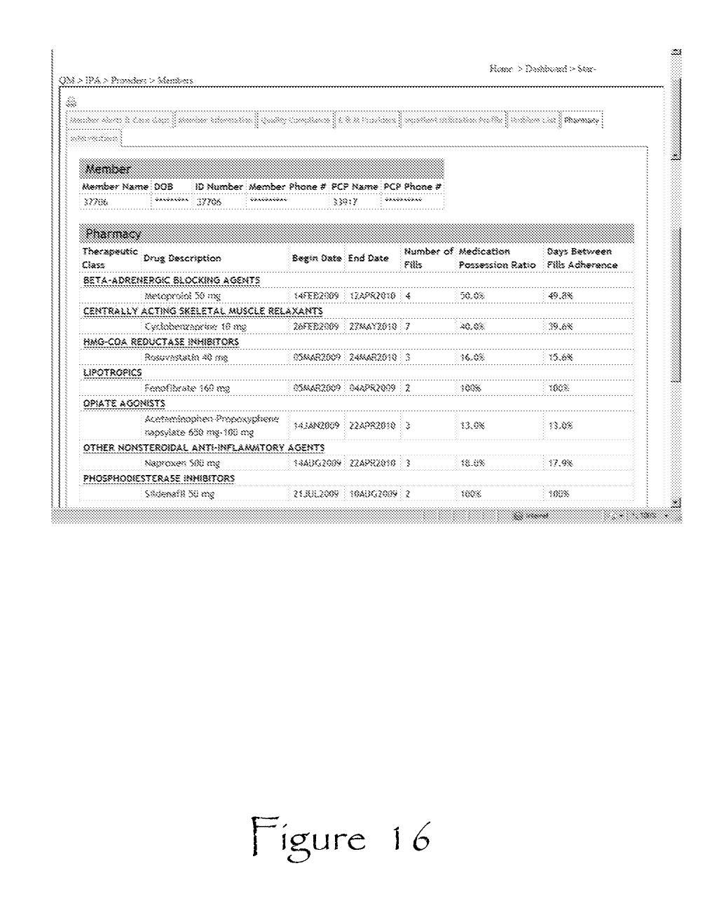

FIG. 16 shows the Member Pharmacy tab. The member's pharmacy compliance measures are listed under the Pharmacy tab in the Member Profile. For each medication in which a claim was submitted to the health plan, the therapeutic class is listed, as well as the description of the medication. As with the Medication History tab, if any, the data are aggregated, and the beginning and end date of each medication is listed for the data collection period. The number of medication refills for each prescription is included in the count under the column entitled “Number of Fills”. Two adherence or compliance measures are calculated for consideration by the member's clinician, care management, or disease management teams. The first is “Medication Possession Ratio” and the other is “Days Between Fills Adherence”. The two measures use different methodologies to measure adherence. Adherence is defined as the extent to which a patient acts in accordance with the prescribed interval and dose of a dosing regimen.

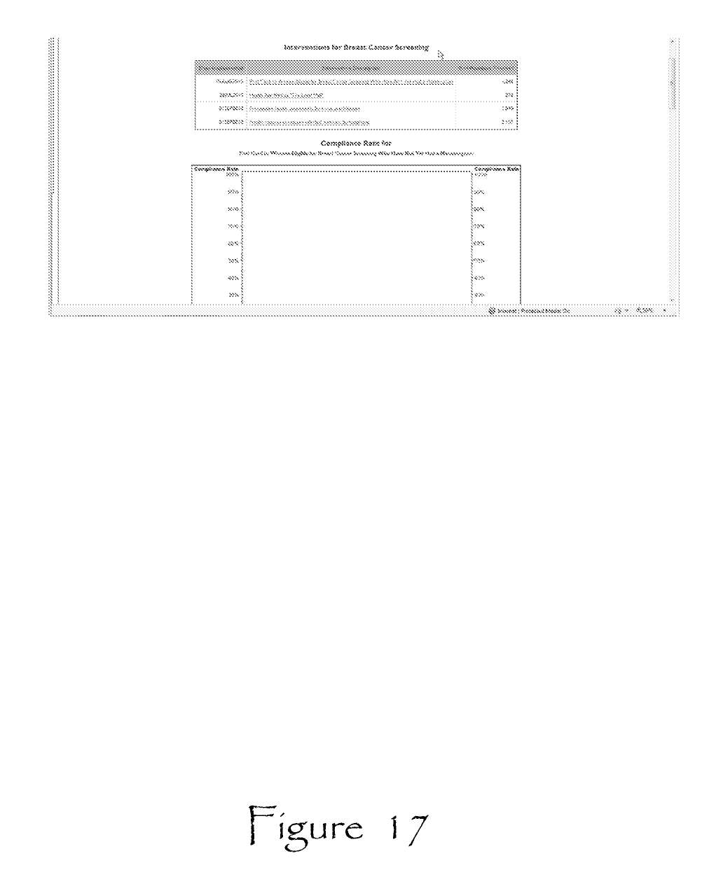

FIG. 17 shows an example of an Intervention Tab for Breast Cancer Screening. Preferably, the system incorporates a workflow tool to track member and/or provider outreach to resolve gaps in care. The intervention may include information mailings, reminders, health fairs, and direct contact. Preferably, the number of members reached by each type of intervention for each IPA is listed. In some embodiments, a graph or other display of the compliance rate to measure the effectiveness of the intervention may be provided. The system tracks member and provider targeted interventions implemented by the plan to affect CMS Stars ratings, trend outcomes, and analyze results. It will also be able to conduct statistical analyses to determine the most effective interventions for the plan and can transmit alerts and communications to members and/or providers to resolve gaps in care

Efficiency Metrics Module

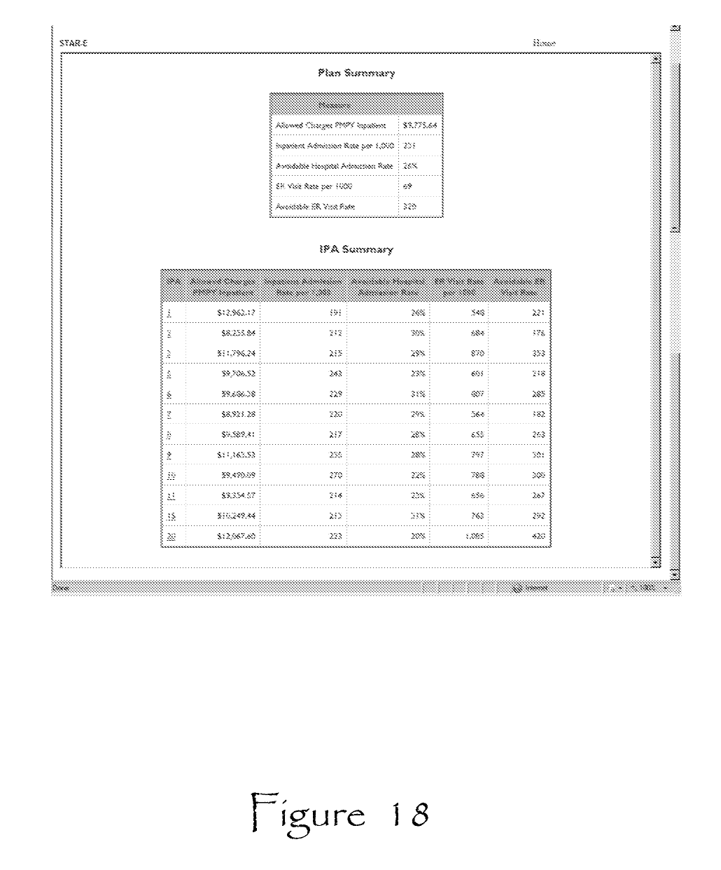

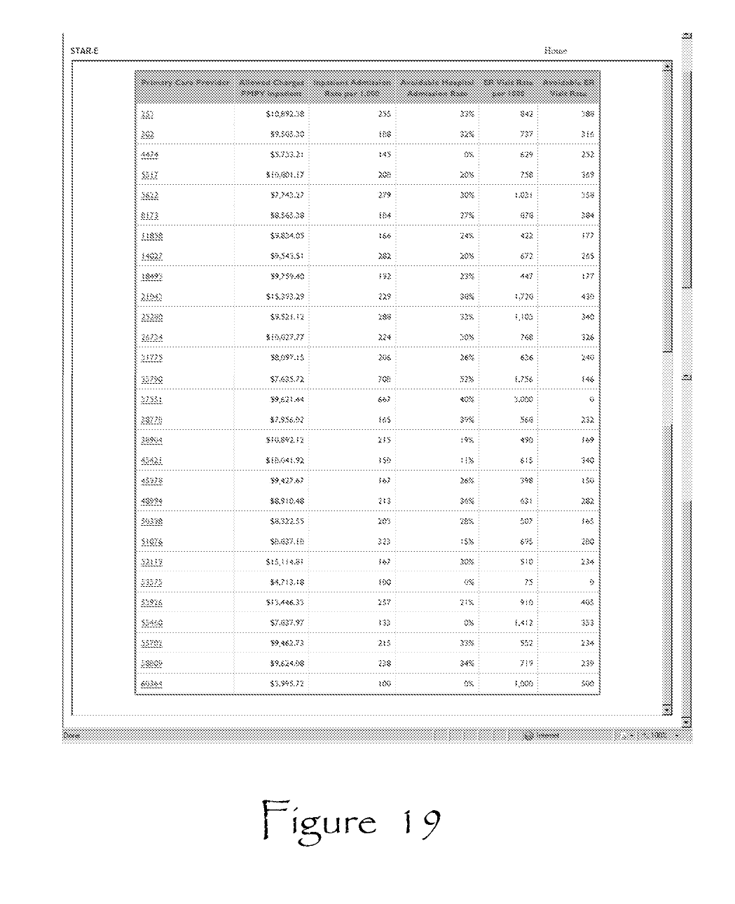

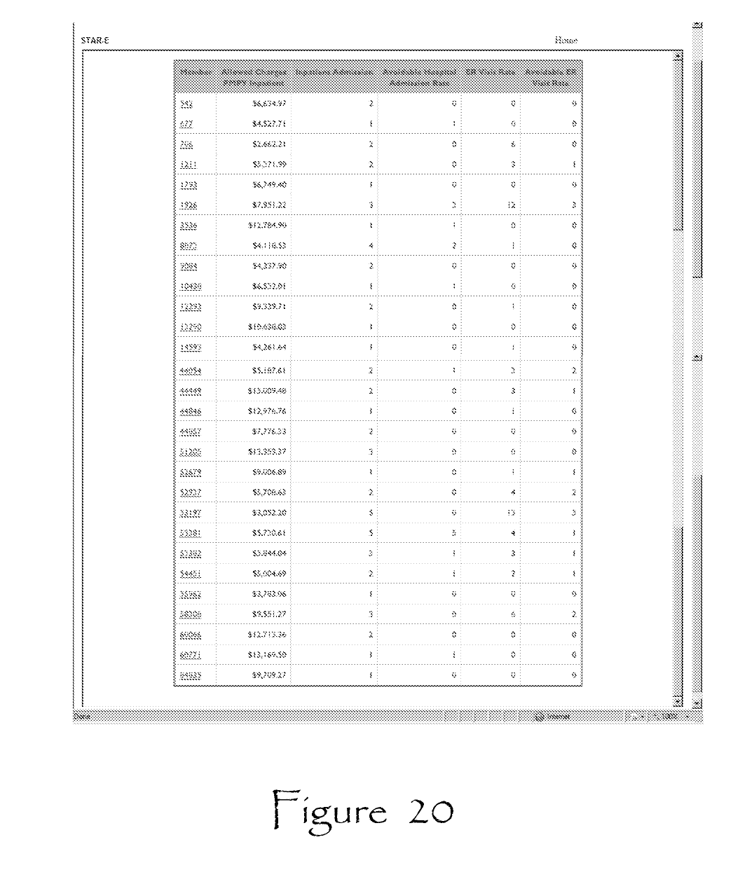

Referring to FIG. 18, the plan summary screen of STAR-E or efficiency module lists the administrative measures for which the system performs calculations. The efficiency metrics module focuses on the management and administrative efficiency functions of the system, including revenue management, avoidable and non-avoidable inpatient admission rates, and preventable emergency department encounters. STAR-RM or risk module focuses on the risk management functions of the system, including management of a plan's RAFs. A user can focus on a particular provider group or individual provider. In some embodiments, a user can search for a provider group by name or an individual provider by name or provider ID.As with the STAR-QM module, the information is summarized for each IPA and for the entire plan. FIG. 19 shows a list of Primary Care Providers and their associated efficiency metrics. Drilling down further, FIG. 20 shows a list of members for one primary care provider and their associated efficiency metrics. Clicking on any of the member numbers brings up a link to the comprehensive member profile shown in FIGS. 10-17.

The system also allows the data feed and the calculated performance metrics to be stratified by other variables in the data feed to examine the data at different levels of aggregations. For example, quality levels, medical efficiency, and/or risk scores are reviewed for the members utilizing a particular provider. Common levels of aggregation can be:
Plan Level
PCP (primary care physician as elected by the member)
Predominant Provider (actual provider who is predominant based upon utilization based on number of visits)
Provider to the Member
County of residence
Contract number
Disease state
Member

This enables system users (i.e., health care plans) and providers to monitor measures not only at the plan level, but all the way down to the member/patient level, so that those measures can be taken into account when making business and healthcare decisions.

Risk Management Module

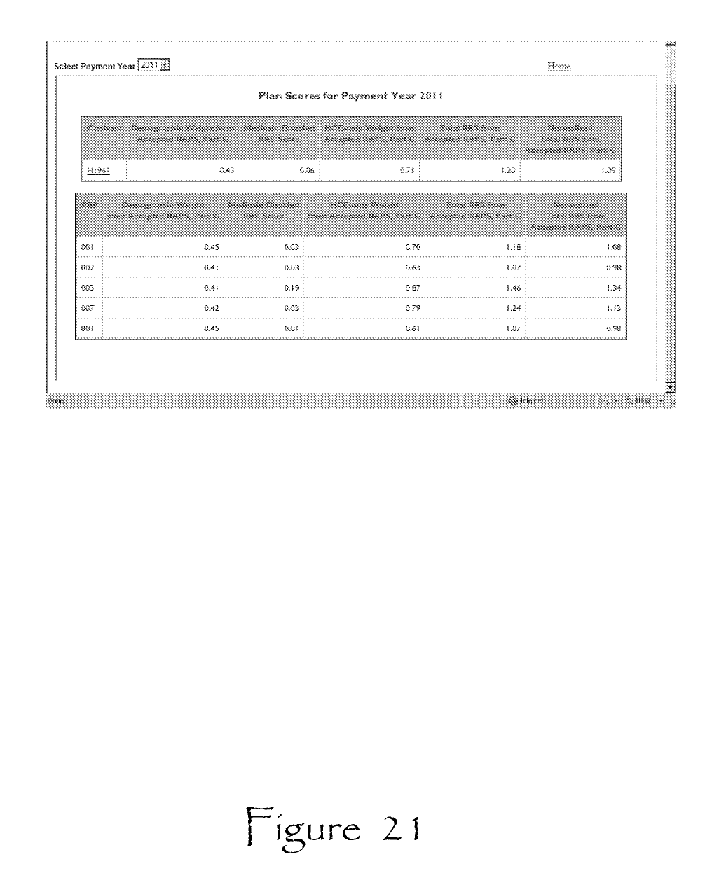

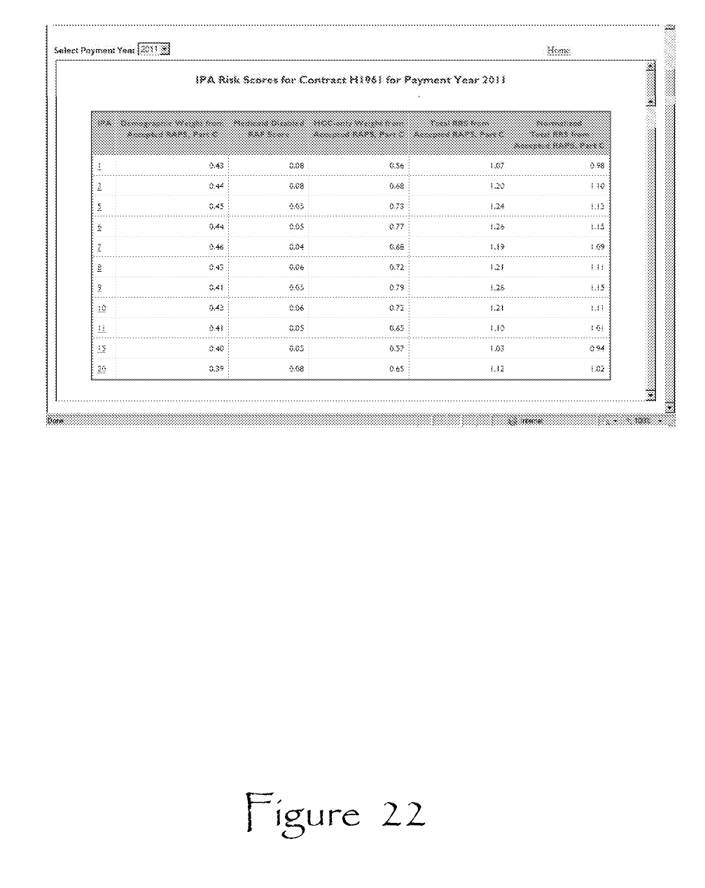

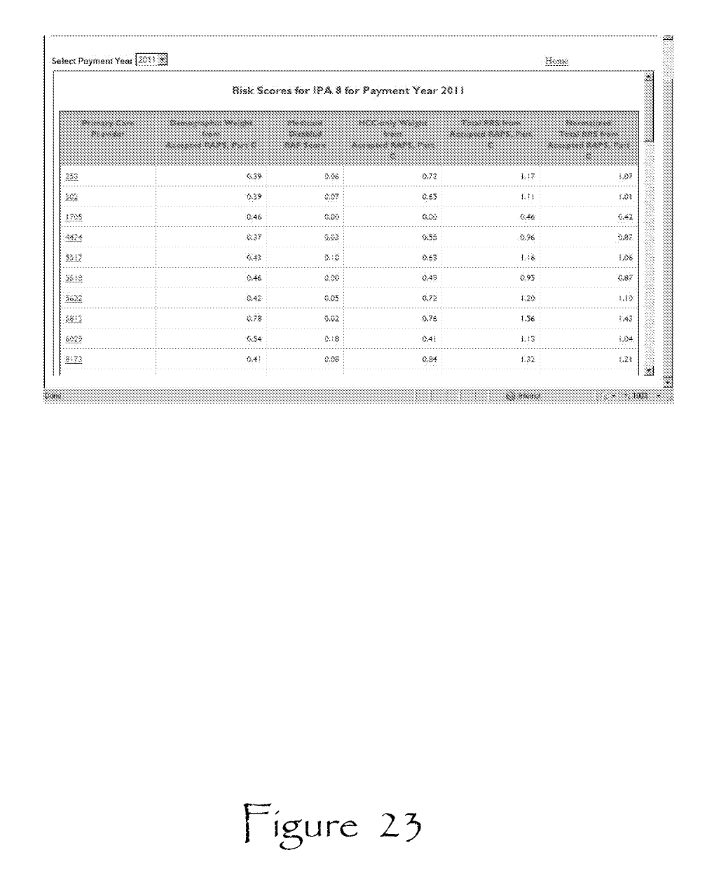

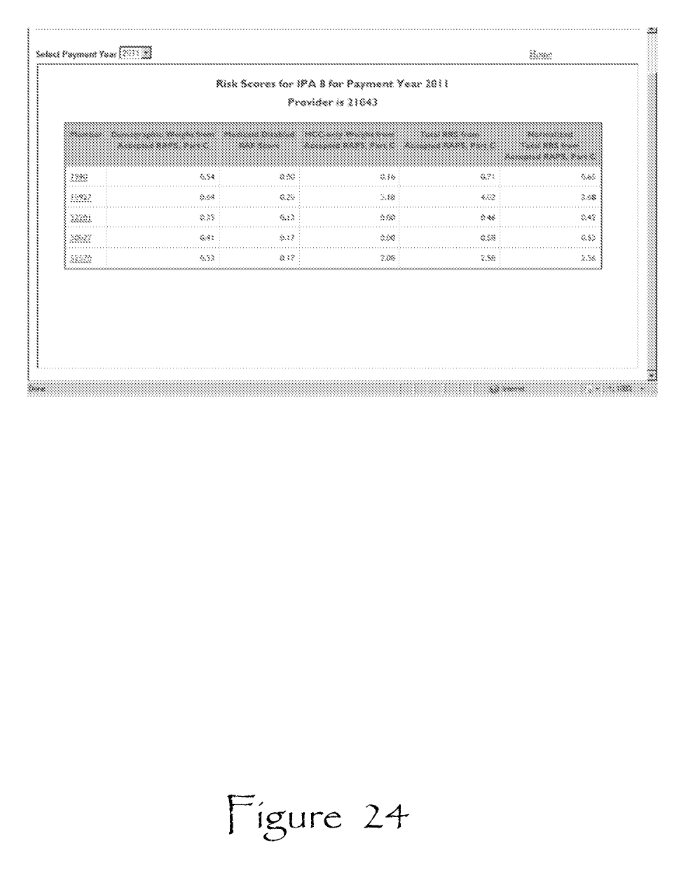

By selecting the STAR-RM module from the Home Page, a user is directed to a plan score page, such as shown in FIG. 21. This module is used for risk assessment. As with the other modules, the information can be summarized for each IPA and for the entire plan, by contract and by payment year. FIG. 22 shows a list of IPA Risk Scores for a single payment year. This can be further broken down for a single IPA as shown in FIG. 23 and further for members for one primary care provider as shown in FIG. 24. Again, clicking on any of the member numbers brings up a link to the comprehensive member profile shown in FIGS. 10-17.

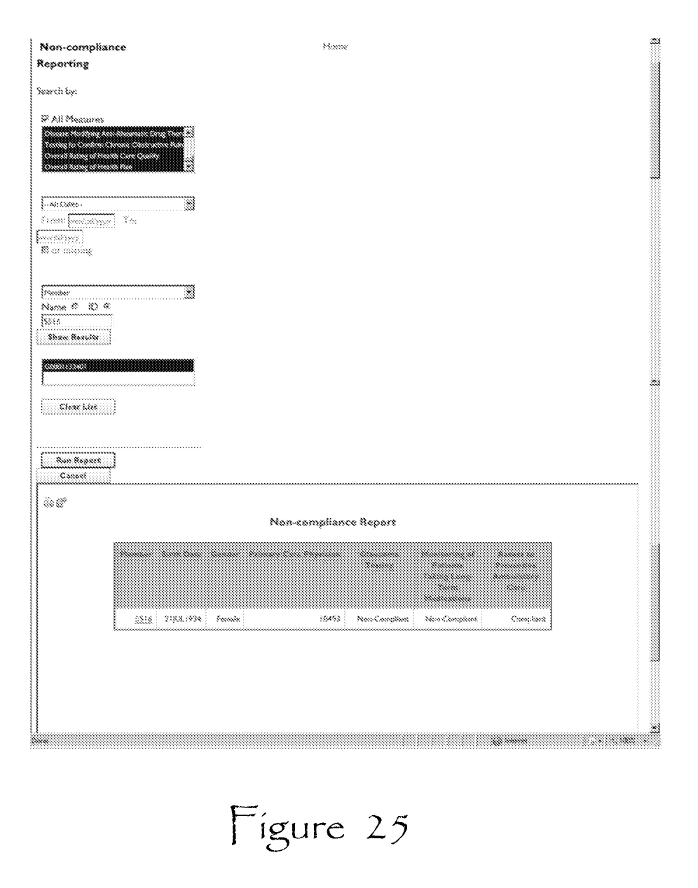

FIG. 25 shows the non-compliance reporting portion of the system. In a preferred embodiment, the system identifies members who are noncompliant with any HEDIS measure. At the plan level, it can report all noncompliant members for all measures or a select measure. Functionality includes a search by PCP or member. A summary report is also available to identify the number of members that need to be touched for each measure and overall.

The system described above is implemented through the use of a computer that has instructions if the form of executable source code and binary code that enable it to process the health information data, generate processed health information data, and present the health information data to the user. The computer can be a stand-alone apparatus or part of a network. The executable source code is installed on a server that facilitates its execution. The server also includes the common data warehouse that stores all the relevant data.

In some preferred embodiments, information from the various modules is combined in order to determine the optimal interventions necessary to improve star ratings for the plan, practice, or physician. For example, risk metrics data is combined with quality or efficiency data to provide star rating that takes into account both categories of information. In one specific example, the progress toward a particular compliance level, as shown through the efficiency metrics module, for the “all-cause hospital readmission measure” is stratified by the risk score of the member (higher risk scores mean members with more comorbidities and hence probably at higher risk for a readmission). In another example, a health plan manager views progress toward meeting quality thresholds (Star ratings) while at the same time checking the risk scores for the same groupings of physicians, such as an IPA. In this second example, the efficiency module and risk module together provide the required information. The ability to view the risk scores, efficiency scores, and quality scores allows users, from plan managers to physicians to take specific steps to improve the overall performance of the program, plan, or practice.

In another embodiment of the present invention, a method for managing health care quality is provided. The method comprises several steps. In the first step, the health information data is collected from various sources as explained above. For example, in one embodiment the data is obtained from government sources such as the HEDIS. In other embodiments, data is collected from a plan's own historical source. In yet further embodiments, surveys are used to collect the data. Once the data is collected, it is placed on a common data warehouse. As explained previously, the common data warehouse can be a single database or a collection of databases to which a health quality information module has access.

Once the data is collected, the data is processed and made available to the user. The method provides multi-level access for a user in a single computing environment and through a single, integrated user interface. Specifically, the user may use such single, integrated platform to access, analyze, and report on information that is particularly applicable to a user at plan, practice, individual practice association, physician group, individual physician and enrollee levels.

In another step of the method, processed health quality data is presented through at least one health quality information data module. The health information data module in one embodiment is a quality metrics module, an efficiency metrics module, or a risk metrics module as described above. The processed data presented to the user includes quality data, such as progress towards star ratings. The process data may also include efficiency data such as avoidable and non-avoidable inpatient admission rates. The processed data may also include risk management data. The three types of data can be used together to provide the user additional information in a single interface about a particular plan or healthcare practice progress towards stated goals. In yet a further step of the method, progress towards a particular goal is tracked and presented to the user.

In yet another embodiment of the present invention, a computer software product containing a software program for executing the method described herein and implementing the system described above enables a person of ordinary skill in the art to manage a healthcare quality management program.

It will be appreciated by persons skilled in the art that numerous variations and/or modifications may be made to the invention as shown in the specific embodiments, without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood that the invention may be practiced otherwise than as specifically set forth herein. The present embodiments are, therefore, to be considered in all respects as illustrative and not restrictive.

What is claimed is:

1. A computer implemented healthcare quality management system comprising:
at least one health information data module configured to process health information data and present processed health information data to a user at plan, practice, individual practice association, physician group, individual physician and enrollee levels.

2. The system of claim 1, wherein the health information data comprises at least one of data from the Health Effectiveness Data and Information Set (HEDIS), PQ4 program data, Consumer Assessment of Health Care Providers and Systems (CAHPS) data, Health Outcome Survey (HOS) data, health management company generated data, and health care provider generated data.

3. The system of claim 1, wherein the user is selected from the group consisting of an Individual Practice Associations (IPA) executive, a quality improvement staff member, a medical practice manager, a health insurance network manager, a health insurance network staff member, a health care case manager, a disease manager, a risk adjustment team member, a healthcare service provider, and a plan enrollee.

4. The system of claim 1, wherein the at least one health information data module is selected from the group consisting of a quality metrics module, an efficiency metrics module, and a risk metrics module.

5. The system of claim 1, wherein the quality metrics module calculates quality star ratings for at least one of a plan, an individual practice association (IPA), a physician group, and an individual healthcare practitioner.

6. The system of claim 5, wherein the system displays quality star ratings to the user.

7. The system of claim 5, wherein the quality metrics module calculates a plan, IPA, physician group, or individual healthcare practitioner's likelihood of meeting star rating thresholds and displays the results of the calculation to the user.

8. The system of claim 5, wherein the quality metrics module provides information to the user on how to achieve a selected star rating.

9. The system of claim 4, wherein the efficiency metrics module calculates a plan, IPA, physician group, or individual healthcare practitioner's efficiency and presents that information to the user.

10. The system of claim 9, wherein the efficiency metrics module's calculations provide information for at least one of the following categories: allowed charges per member per year inpatient, non-avoidable inpatient admission rates, avoidable inpatient admission rates, non-avoidable emergency room visit rates, and avoidable emergency room visit rates.

11. The system of claim 4, wherein the efficiency metrics module calculates revenue values and presents processed revenue values to the user.

12. The system of claim 4, wherein the risk management module calculates a plan, IPA, physician group, or individual healthcare practitioner's risk adjustment factors and related information and presents that information to the user.
